(19) United States
(12) Patent Application Publication
(10) Pub. No.: US 2014/0087018 A1
(43) Pub. Date: Mar. 27, 2014

(54) READY TO EAT BLOOD PATTIES, BLOOD BALLS, AND BLOOD BURGERS

(71) Applicant: Alice Chang, South Pasadena, CA (US)

(72) Inventor: Alice Chang, South Pasadena, CA (US)

(21) Appl. No.: 13/864,109

(22) Filed: Apr. 16, 2013

Related U.S. Application Data
(60) Provisional application No. 61/705,758, filed on Sep. 26, 2012.

(51) Int. Cl. A23L 1/313

(52) U.S. Cl. CPC A23L 1/313
USPC 426/2; 426/647; 426/645; 426/644

(57) ABSTRACT

A ready to eat blood patties, blood balls, and blood burgers comestible having ingredients combined in proportions substantially including: coagulated animal blood; and at least one seasoning. The animal blood is cooled in a refrigerator once the animal blood is drawn from the animal to coagulate the animal blood. The animal blood, once coagulated in the refrigerator is cut into desired different shapes and sizes of the blood patties, the blood balls, and the blood burgers comestible. The ready to eat blood patties, blood balls, and blood burgers comestible is prepared by intermixing the animal blood, and the seasonings, when prepared and are cooked, the blood patties, the blood balls, and the blood burgers comestible being high in nutrition, including iron, low in animal fats and suitable for readily consuming.

### CROSS-REFERENCE TO RELATED APPLICATION

The present application is related to and claims priority from prior provisional application Ser. No. 61/705,758, filed Sep. 26, 2012 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. Field of the Invention

The present invention relates generally to the field of comestibles and more specifically relates to ready to eat blood patties, blood balls, and blood burgers.

### 2. Description of the Related Art

The majority of people desire a healthy lifestyle; however many individuals do not feel that they have time to cook healthy meals in modern society. Due to rushed schedules many individuals eat unhealthy foods that may lead to obesity and other serious health problems. Blood is a specialized bodily fluid in animals that delivers necessary substances such as nutrients and oxygen to the cells and transports metabolic waste products away from those same cells.

In vertebrates, it is composed of blood cells suspended in a liquid called blood plasma. Plasma, which constitutes 55% of blood fluid, is mostly water (92% by volume), and contains dissipated proteins, glucose, mineral ions, hormones, carbon dioxide (plasma being the main medium for excretory product transportation), and blood cells themselves. Albumin is the main protein in plasma, and it functions to regulate the colloidal osmotic pressure of blood. The blood cells are mainly red blood cells and white blood cells, including leukocytes and platelets. The most abundant cells in vertebrate blood are red blood cells. These contain hemoglobin, an iron-containing protein, which facilitates transportation of oxygen by reversibly binding to this respiratory gas and greatly increasing its solubility in blood.

Blood is high in nutrition, including iron, low in animal fats and suitable for readily consuming however a convenient and appetizing solution is desirable. A more efficient and convenient option is needed to provide people shopping for food the convenience of getting processed blood products, and people who eat at fast food restaurants the choice of blood burgers.

Various attempts have been made to solve the above-mentioned problems such as those found in U.S. Pat. Nos. 4,293,576; 2,241,868; 4,143,168; 4,262,022; 1,956,784; 1,599,030; and 2002/0123615. This art is representative of processes and comestibles relating to animal blood. None of the above inventions and patents, taken either singly or in combination, is seen to describe the invention as claimed.

Ideally, ready to eat blood patties, blood balls, and blood burgers should provide a nutritional comestible comprising animal blood that is convenient to prepare and desirable to eat and, yet would be able to be processed and manufactured at a modest expense. Thus, a need exists for healthy ready to eat blood patties, blood balls, and blood burgers to avoid the above-mentioned problems.

### BRIEF SUMMARY OF THE INVENTION

In view of the foregoing disadvantages inherent in the known comestibles art, the present invention provides novel ready to eat blood patties, blood balls, and blood burgers. The general purpose of the present invention, which will be described subsequently in greater detail is to provide a nutritional comestible comprising animal blood that is convenient to prepare and desirable to eat.

The purpose of the present invention is to create ready to eat blood patties, blood balls, and blood burgers. The ready to eat blood patties, blood balls, and blood burgers provide people shopping for food the convenience of getting processed blood products, and people who eat at fast food restaurants the choice of blood burgers. Blood patties and blood balls can contain blood drawn from animals such as cow, pig, deer, lamb, duck, chicken, goose, etc. Instead of animal slaughter, the animal can be kept alive when blood is taken from the live animal and the wound is allowed to heal, thus creating a sustainable process for providing a blood source that may be processed and eaten as described subsequently. Further, when the animal is slaughtered, the blood is saved instead of wasted.

Ready to eat blood patties, blood balls, and blood burgers comestible is disclosed herein comprising ingredients combined in proportions substantially including: at least one coagulated animal blood; and at least one seasoning. The at least one animal blood, and seasoning are combined. The seasoning is selected from the group consisting of salt, pepper, onion, garlic, ginger, curry, chili, vinegar, lemon, lime, peppermint, basil, thyme, parsley, rosemary, soup stock, broth, clove, cinnamon, coriander, cumin, and shallots. The ready to eat blood patties, blood balls, and blood burgers comestible is prepared by intermixing the at least one animal blood, and the seasonings, when prepared and are cooked, the blood patties, the blood balls, and the blood burgers comestible being high in nutrition, including iron, low in animal fats and suitable for readily consuming.

The animal blood is cooled in a refrigerator once the animal blood is drawn from the animal to coagulate the animal blood. The at least one animal blood(s) is collected from an animal, the animal selected from the group consisting of cow, pig, deer, lamb, duck, chicken, and goose. The at least one animal blood is cooked to make blood patties, blood balls, and blood burgers comestible. The at least one animal blood, once coagulated in the refrigerator is cut into desired different shapes and sizes of blood patties, blood balls, and blood burgers comestible. Suitable means for creating safe and consistent coagulation is well known within the art. The blood patties comprise disks having dimensions approximately 3 to 4 inches in diameter, having a thickness of approximately ½ to 1-inch in thickness, and are such that they may be evenly and thoroughly cooked.

The animal blood may comprise an outer coating as formed on the blood patties, the blood balls, and the blood burgers. The outer coating is selected from the group consisting of bread crumbs, beer batter, egg batter, and cornmeal batter. The cooking means when cooked are selected from the group consisting of deep frying, grilling, boiling, baking, and steaming. Ready to eat blood patties, blood balls, and blood burgers when prepared via deep frying, use cooking oil(s). The cooking oil(s), when used, are selected from the group consisting of corn oil, canola oil, sunflower oil, peanut oil, olive oil, coconut oil, sesame oil, grape seed oil, flaxseed oil, soybean oil, pumpkin seed oil, safflower oil, argan oil, rice bran oil, palm oil, and palm kernel oil.

The blood patties, the blood balls, and the blood burgers may be served in combination with at least one garnish; the at least one garnish is selected from the group consisting of lettuce, onions, tomatoes, pickles, and cheese. Further, the blood patties, the blood balls, and the blood burgers are served in combination with sides; the sides are selected from the group consisting of bread buns, potatoes, rice, and pasta. The blood patties, the blood balls, and the blood burgers may be served in combination with at least one condiment, the at least one condiment are selected from the group consisting of mustard, mayonnaise, ketchup, and relish.

A method of preparing ready to eat blood patties, blood balls, and blood burgers comestible is also disclosed herein comprising the steps of: drawing blood from at least one animal; refrigerating the blood from the animal to create coagulation; seasoning the blood from the animal; cutting the blood from the animal into pieces of varying shapes and sizes to create the blood patties (once coagulated), cooking the blood from the animal; garnishing the blood patties, the blood balls, and the blood burgers with a bun and condiments; serving the ready to eat blood patties, blood balls, and blood burgers as hot food in restaurants, ready to eat blood patties, blood balls, and blood burgers comestibles which may be packaged into air tight containers to preserve freshness until ready for consumption; and consuming the blood patties, the blood balls, and the blood burgers.

The present invention holds significant improvements and serves as ready to eat blood patties, blood balls, and blood burgers. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, ready to eat blood patties, blood balls, and blood burgers, constructed and operative according to the teachings of the present invention.

FIG. 1 shows a perspective view illustrating ready to eat blood patties, blood balls, and blood burgers according to an embodiment of the present invention.

FIG. 2 is a perspective view illustrating the ready to eat blood patties, blood balls, and blood burgers as used to make embodiments of the present invention of FIG. 1.

FIG. 3 is a flowchart illustrating a method of preparing the ready to eat blood patties, blood balls, and blood burgers comestibles according to an embodiment of the present invention of FIGS. 1-2.

The various embodiments of the present invention will hereinafter be described in conjunction with the appended drawings, wherein like designations denote like elements.

### DETAILED DESCRIPTION

As discussed above, embodiments of the present invention relate to comestibles and more particularly to ready to eat blood patties, blood balls, and blood burgers comprising animal blood that is convenient to prepare and desirable to eat.

Generally speaking, the purpose, as previously mentioned, is to create ready to eat blood patties, blood balls, and blood burgers. The ready to eat blood patties, blood balls, and blood burgers provide people shopping for food the convenience of getting processed blood products, and people who eat at fast food restaurants the choice of blood burgers. Blood patties and blood balls can contain blood drawn from animals such as cow, pig, deer, lamb, duck, chicken, goose, and the like. Instead of animal slaughter, the animal can be kept alive when blood is taken from the live animal and the wound is allowed to heal. Further, when the animal is slaughtered, the blood is saved instead of wasted.

The animal blood can be refrigerated to congeal or solidify (other congealment means may be used), and then cut into different shapes and sizes of patties and balls. The blood patties, blood balls, and blood burgers have high nutritional value, rich in iron, and low in animal fats. The blood patties may be shaped into round or square patties. The round patties may have a diameter of approximately 3 to 4 inches. The square patties may have each side of approximately 3 to 4 inches. Further, the patties may comprise a thickness of approximately ½ to 1 inch. The blood balls may be shaped into spherical or cubical shapes. The spherical blood balls may have a diameter of about 1 to 2 inches. And the cubical blood balls may have each side of about 1 to 2 inches. It should be noted that other shapes and sizes may also be considered.

An outer layer can be added if needed, such as bread crumbs, egg batter, beer batter, cornmeal batter. Seasonings used to make blood patties, blood balls, and blood burgers may include salt, pepper, onion, garlic, ginger, curry, chili, vinegar, lemon, lime, peppermint, basil, thyme, parsley, rosemary, soup stock and broth. Other seasonings used may include clove, cinnamon coriander, cumin, shallots. Ingredients and seasonings can be added and mixed into the blood before the blood is coagulated in the refrigerator. They can include minced herbs and spices, and various seasonings and flavorings. Other ingredients can also be used, including ingredients that are ground, minced, semi-solid, or liquid. The other ingredients include egg, meat, seafood, vegetable, herb, fruit, cereal, nut, bean, cheese, butter, and so on.

When the blood is fried, vegetable oils include corn oil, canola oil (rapeseed oil), sunflower oil, peanut oil, olive oil, coconut oil, sesame oil, grape seed oil, flaxseed oil, soybean oil, pumpkin seed oil, safflower oil, argan oil, rice bran oil, palm oil, palm kernel oil, and other vegetable oils. The seasonings and flavorings can be added and mixed into the cooking oils before deep frying. Additionally, the seasonings can also be added and mixed into the seafood after deep frying.

The ready to eat blood patties, blood balls, and blood burgers are cooked by frying, grilling, boiling, steaming, baking, etc. Also, the ready to eat blood patties, blood balls, and blood burgers can be seasoned with salt, pepper, onion, garlic, ginger, curry, chili, vinegar, lemon, lime, peppermint, basil, thyme, parsley, rosemary, soup stock and broth, clove, cinnamon, coriander, cumin, shallot, or the like. Ingredients and seasonings can be added and mixed into the blood before the blood is coagulated in the refrigerator. They can include minced herbs and spices, and various seasonings and flavorings.

At fast food restaurants, the blood patties can be fried or grilled, seasoned, and placed inside a sliced bread roll to make a blood burger. The blood burger can be served with lettuce, onion, tomato, pickle, cheese, and condiments such as mustard, mayonnaise, ketchup, and relish. The blood balls may be served as an appetizer. Hamburger meat and steak made of beef are usually not fully cooked, but the blood patties, blood balls, and blood burgers are all well done.

The cooked and seasoned blood patties, blood balls, and blood burgers can be packaged into air tight containers. The containers can be made of paper, plastic, glass, metal.

In an alternate embodiment, the present invention may be in the form of sausages. Other ingredients cannot mix with the blood unless they are in a sausage casing. The blood can be made into sausages, and other ingredients can be added in making the blood sausages. The other ingredients for the fillers include meat, fat, suet, bread, rice, barley, oatmeal, cereal, nut, bean, seafood, egg, cheese, butter, vegetable, fruit, herb, seasoning, and so on. Further, the fillers can be added and mixed in with the blood, to form an even and smooth texture.

The casing is made from an elongated tube-like thin layer of gelatin, or a spherical shaped thin layer of gelatin, in small and large sizes. The tube like casing can range from about ½ inch in diameter to about 2 inches in diameter, and a length of about 2 inches to 8 inches. The spherical shaped casing can range from about 1 to 2 inches in diameter. Other shapes and sizes can also be considered, such as cubical shape and cylindrical shape. Other types of casing can also be used, such as cleaned intestine, collagen, and cellulose.

A method of use for making the ready to eat blood patties, blood balls, and blood burgers includes the steps of: frying, grilling, boiling, steaming, or baking the blood patties, blood balls, or blood burgers; and seasoning the blood patties, blood balls, and blood burgers with salt, pepper, onion, garlic, ginger, curry, chili, vinegar, lemon, lime, peppermint, basil, thyme, parsley, rosemary, soup stock and broth, clove, cinnamon, coriander, cumin, shallots, and the like.

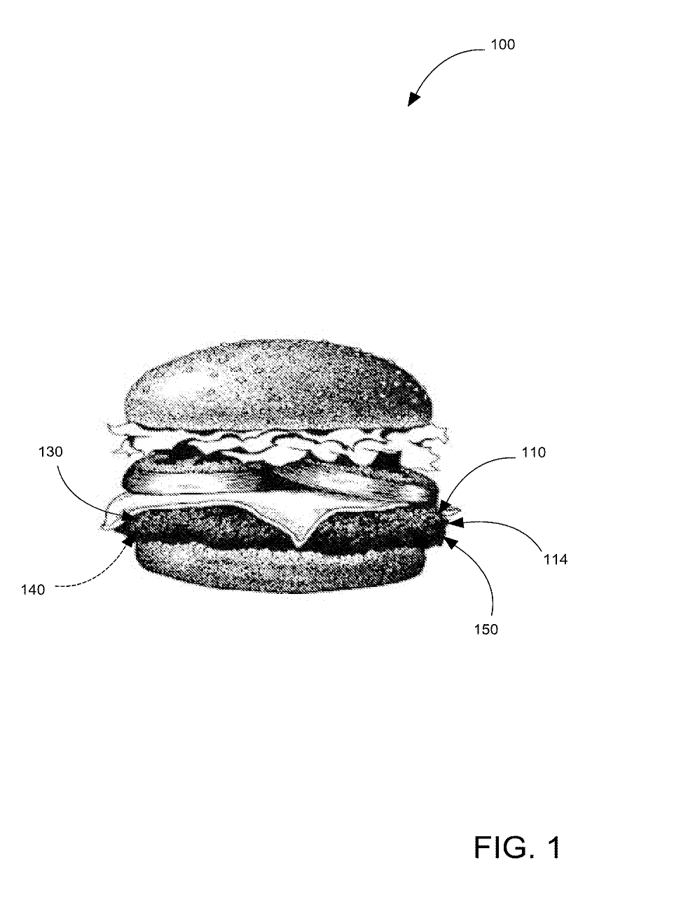

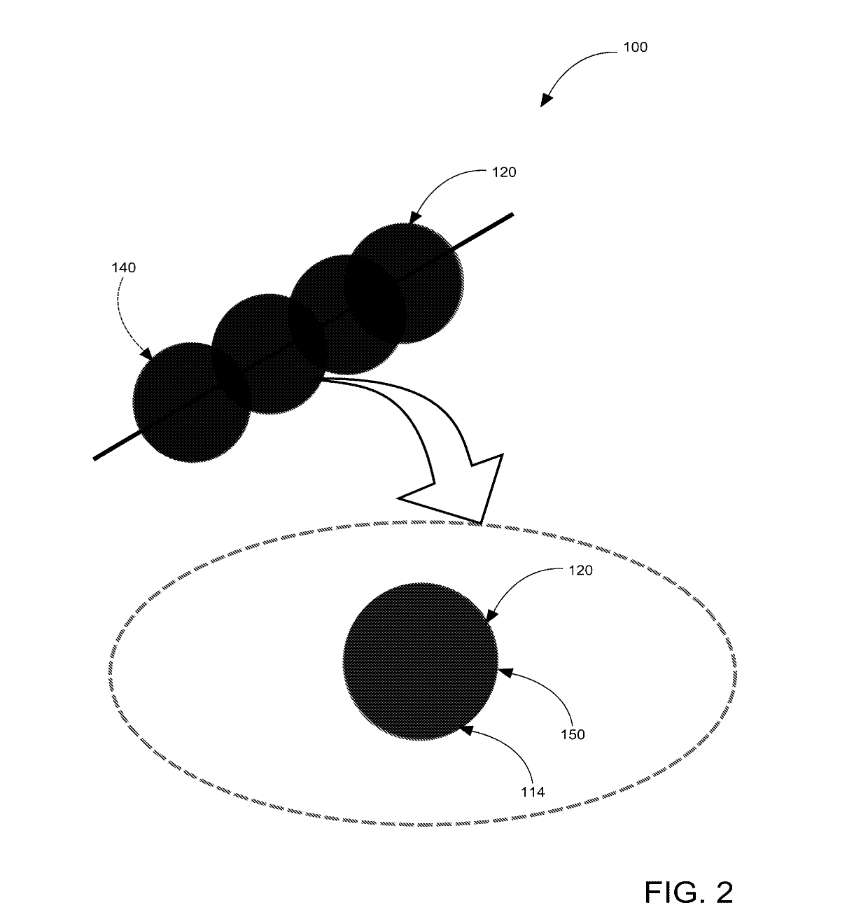

Referring to the drawings by numerals of reference there is shown in FIGS. 1-2 showing perspective views illustrating ready to eat blood patties 110, blood balls 120, and blood burgers 130 comestible 100 (once prepared to be eaten), to be prepared both according to embodiments of the present invention.

Ready to eat blood patties 110, blood balls 120, and blood burgers 130 comestible 100 preferably comprises ingredients combined in proportions substantially including: at least coagulated animal blood 140; and at least one seasoning 150. The at least one animal blood 140, and seasoning 150 are preferably combined. Seasoning 150 is preferably selected from the group consisting of salt, pepper, onion, garlic, ginger, curry, chili, vinegar, lemon, lime, peppermint, basil, thyme, parsley, rosemary, soup stock and broth, clove, cinnamon, coriander, cumin, shallots. Ready to eat blood patties 110, blood balls 120, and blood burgers 130 comestible 100 is prepared by intermixing the at least one animal blood 140, and seasonings 150, when prepared and are cooked, ready to eat blood patties 110, blood balls 120, and blood burgers 130 comestible 100 being high in nutrition, including iron, low in animal fats and suitable for readily consuming.

Animal blood 140 is cooled in a refrigerator once animal blood 140 is drawn from the animal to coagulate animal blood 140. At least one animal blood(s) 140 is collected from an animal, the animal selected from the group consisting of cow, pig, deer, lamb, duck, chicken, and goose. At least one animal blood 140 is cooked to make blood patties 110, blood balls 120, and blood burgers 130 comestible 100. At least one animal blood 140, once coagulated in the refrigerator and prepared is cut into desired different shapes and sizes of ready to eat blood patties 110, blood balls 120, and blood burgers 130 comestible 100.

Blood patties 110 preferably comprise disks having dimensions approximately 3 to 4 inches in diameter, having a thickness of approximately ½ to 1-inch in thickness, and are such that they may be evenly and thoroughly cooked. Blood patties 110 may also comprise cubical shapes having dimension approximately 3 to 4 inches in length, have a thickness of approximately ½ to 1-inch in thickness, and such that they may be evenly and thoroughly cooked. Blood balls 120 may also comprise balls (or rounded disks) having dimensions approximately 1 to 2 inches in diameter, and such that they may be evenly and thoroughly cooked. Blood balls 120 may also comprise cubical shapes having dimensions approximately 1 to 2 inches in length, and such that they may be evenly and thoroughly cooked.

Animal blood 110 may comprise outer coating 114 in preferred embodiments. Outer coating 114 (when used) is selected from the group consisting of bread crumbs, beer batter, egg batter, and cornmeal batter. In some embodiments, animal blood 140 may comprises no outer coating (not shown) as formed ready to eat blood patties 110, blood balls 120, and blood burgers 130 comestible 100 since it is healthier for consumption. Animal blood 140 may be congealed to be able to be formed using appropriate means such as flour or the like.

The cooking means when cooked are selected from the group consisting of deep frying, grilling, boiling, baking, and steaming. Ready to eat blood patties 110, blood balls 120, and blood burgers 130 comestible 100 when prepared via deep frying, cooking oil(s) is used. The cooking oil(s), when used, are selected from the group consisting of corn oil, canola oil, sunflower oil, peanut oil, olive oil, coconut oil, sesame oil, grape seed oil, flaxseed oil, soybean oil, pumpkin seed oil, safflower oil, argan oil, rice bran oil, palm oil, and palm kernel oil. Cooking is done before the present invention is ready to slice or to eat.

Ready to eat blood patties 110, blood balls 120, and blood burgers 130 comestible 100 are preferably served in combination with at least one garnish, the at least one garnish is selected from the group consisting of lettuce, onions, tomatoes, pickles, and cheese. Further, ready to eat blood patties 110, blood balls 120, and blood burgers 130 comestible 100 may be served in combination with sides; the sides are selected from the group consisting of bread buns, potatoes, rice, and pasta. Ready to eat blood patties 110, blood balls 120, and blood burgers 130 comestible 100 are served in combination with at least one condiment, the at least one condiment is selected from the group consisting of mustard, mayonnaise, ketchup, and relish.

Ready to eat blood patties 110, blood balls 120, and blood burgers 130 comestible 100 can be packaged into air tight containers to preserve freshness until ready to serve. The containers can be made of paper, plastic, glass, metal. In this way the present invention may be easily shipped and stored.

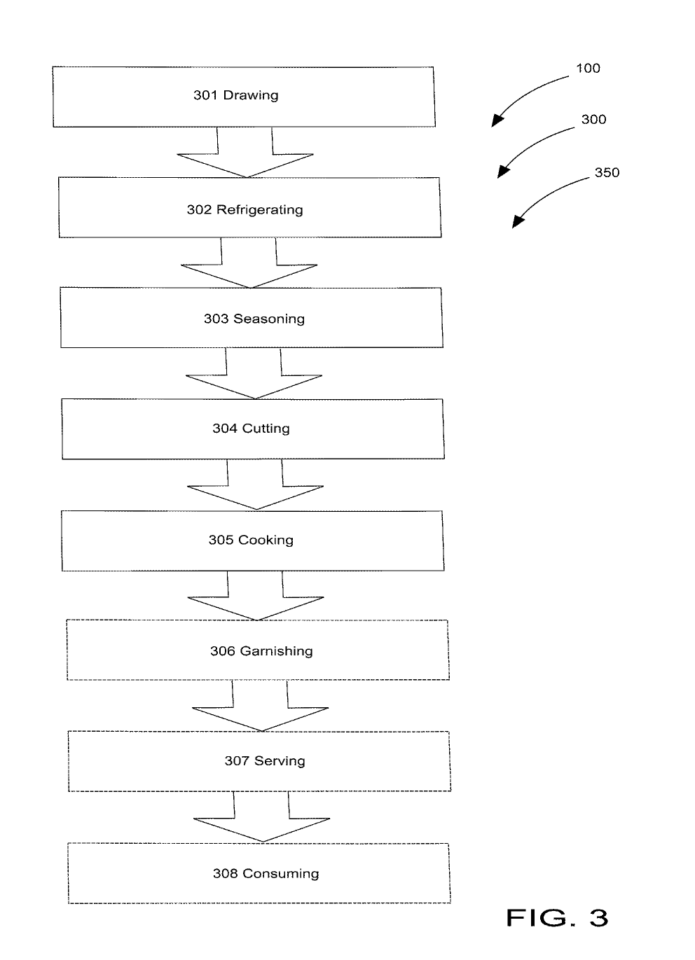

Referring now to FIG. 3, flowchart 350 illustrating a method of preparing 300 ready to eat blood patties 110, blood balls 120, and blood burgers 130 comestible 100, according to embodiments of the present invention of FIGS. 1-2.

Method of preparing 300 ready to eat blood patties 110, blood balls 120, and blood burgers 130 comestible 100 comprises the steps of: step one 301 drawing blood 140 from at least one animal; step two 302 refrigerating blood 140 from animal to create coagulation; step three 303 seasoning blood 140 from the animal; step four 304 cutting (coagulated/congealed) blood 140 from the animal into pieces of varying shapes and sizes to ready to eat blood patties 110, blood balls 120, and blood burgers 130 comestible 100; step five 305 cooking blood 140 from the animal; step six 306 garnishing ready to eat blood patties 110, blood balls 120, and blood burgers 130 comestible 100 with a bun and condiments; step seven 307 optionally serving ready to eat blood patties 110, blood balls 120, and blood burgers 130 comestible 100 as hot food in restaurants, wherein ready to eat blood patties 110, blood balls 120, and blood burgers 130 comestible 100 are packaged into air tight containers to preserve freshness until ready for consumption; and step eight 308 consuming ready to eat blood patties 110, blood balls 120, and blood burgers 130 comestible 100.

Optional steps are in dashed boxes in FIG. 3. The steps may be performed in varying orders for example cooking may be performed before cutting or the like.

It should be noted that the steps described in the method of use can be carried out in many different orders according to user preference. The use of “step of” should not be interpreted as “step for”, in the claims herein and is not intended to invoke the provisions of 35 U.S.C. §112, ¶6. Upon reading this specification, it should be appreciated that, under appropriate circumstances, considering such issues as design preference, user preferences, marketing preferences, cost, structural requirements, available materials, technological advances, etc., other methods of use arrangements such as, for example, different orders within above-mentioned list, elimination or addition of certain steps, including or excluding certain maintenance steps, etc., may be sufficient.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A ready to eat blood patties, blood balls, and blood burgers comestible comprising ingredients combined in proportions substantially including:
at least coagulated animal blood; and
at least one seasoning;
wherein said animal blood is cooled in a refrigerator once said animal blood is drawn from said animal to said coagulate said animal blood;
wherein said at least one animal blood is cooked to make said blood patties, said blood balls, and said blood burgers comestible;
wherein said at least one animal blood, once said coagulated in said refrigerator is prepared and cut into desired different shapes and sizes of said blood patties, said blood balls, and said blood burgers comestible;
wherein said at least one animal blood, and said seasoning are combined; and
wherein said ready to eat blood patties, blood balls, and blood burgers comestible is prepared by intermixing said at least one animal blood, and said seasonings, when prepared and are cooked, said blood patties, said blood balls, and said blood burgers comestible being high in nutrition, including iron, low in animal fats and suitable for readily consuming.

2. The ready to eat blood patties, blood balls, and blood burgers comestible of claim 1 wherein said at least one animal blood(s) is collected from an animal said animal selected from the group consisting of cow, pig, deer, lamb, duck, chicken, and goose.

3. The ready to eat blood patties, blood balls, and blood burgers comestible of claim 2 wherein said animal blood(s) includes at least 2 combinations of said animal blood(s).

4. The ready to eat blood patties, blood balls, and blood burgers comestible of claim 1 wherein said blood patties comprise disks having dimensions approximately 3 to 4 inches in diameter, having a thickness of approximately ½ to 1-inch in thickness, and are such that they may be evenly and thoroughly cooked.

5. The ready to eat blood patties, blood balls, and blood burgers comestible of claim 1 wherein said blood patties comprise cubical shapes having dimension approximately 3 to 4 inches in length, have a thickness of approximately ½ to 1-inch in thickness, and such that they may be evenly and thoroughly cooked.

6. The ready to eat blood patties, blood balls, and blood burgers comestible of claim 1 wherein said blood balls comprise disks having dimensions approximately 1 to 2 inches in diameter, and such that they may be evenly and thoroughly cooked.

7. The ready to eat blood patties, blood balls, and blood burgers comestible of claim 1 wherein said blood balls comprise cubical shapes having dimensions approximately 1 to 2 inches in length, and such that they may be evenly and thoroughly cooked.

8. The ready to eat blood patties, blood balls, and blood burgers comestible of claim 1 wherein said animal blood comprises no outer coating as formed said blood patties, said blood balls, and said blood burgers.

9. The ready to eat blood patties, blood balls, and blood burgers comestible of claim 1 wherein said animal blood comprises an outer coating as formed said blood patties, said blood balls, and said blood burgers.

10. The ready to eat blood patties, blood balls, and blood burgers of claim 9 wherein said outer coating is selected from the group consisting of bread crumbs, beer batter, egg batter, and cornmeal batter.

11. The ready to eat blood patties, blood balls, and blood burgers comestible of claim 1 wherein said cooking means when cooked are selected from the group consisting of deep frying, grilling, boiling, baking, and steaming.

12. The ready to eat blood patties, blood balls, and blood burgers of claim 11 wherein when said ready to eat blood patties, blood balls, and blood burgers when prepared via said deep frying, cooking oil(s) is used.

13. The ready to eat blood patties, blood balls, and blood burgers comestible of claim 12 wherein said cooking oil(s), when used, are selected from the group consisting of corn oil, canola oil, sunflower oil, peanut oil, olive oil, coconut oil, sesame oil, grape seed oil, flaxseed oil, soybean oil, pumpkin seed oil, safflower oil, argan oil, rice bran oil, palm oil, and palm kernel oil.

14. The ready to eat blood patties, blood balls, and blood burgers comestible of claim 1 wherein said at least one seasoning is selected from the group consisting of salt, pepper, onion, garlic, ginger, curry, chili, vinegar, lemon, lime, peppermint, basil, thyme, parsley, rosemary, soup stock and broth, clove, cinnamon, coriander, cumin, and shallots.

15. The ready to eat blood patties, blood balls, and blood burgers comestible of claim 1 wherein said blood patties, said blood balls, and said blood burgers are served in combination with at least one garnish, said at least one garnish is selected from the group consisting of lettuce, onions, tomatoes, pickles, and cheese.

16. The ready to eat blood patties, blood balls, and blood burgers comestible of claim 1 wherein said blood patties, said blood balls, and said blood burgers are served in combination with sides, said sides are selected from the group consisting of bread buns, potatoes, rice, and pasta.

17. The ready to eat blood patties, blood balls, and blood burgers comestible of claim 1 wherein said blood patties, said blood balls, and said blood burgers are served in combination with at least one condiment, said at least one condiment are selected from the group consisting of mustard, mayonnaise, ketchup, and relish.

18. A ready to eat blood patties, blood balls, and blood burgers comestible comprising ingredients combined in proportions substantially including:
at least coagulated animal blood; and
at least one seasoning;
wherein said animal blood is cooled in a refrigerator once said animal blood is drawn from said animal to coagulate said animal blood;
wherein said at least one animal blood is cooked once congealed to make said blood patties, said blood balls, and said blood burgers comestible;
wherein said at least one animal blood, and said at least one seasoning are combined;
wherein said at least one animal blood, once said coagulated in said refrigerator is cut into desired different shapes and sizes of said blood patties, said blood balls, and said blood burgers comestible;
wherein said ready to eat blood patties, blood balls, and blood burgers comestible is prepared by intermixing said at least one animal blood, and said seasonings, when prepared and are cooked, said blood patties, said blood balls, and said blood burgers comestible being high in nutrition, including iron, low in animal fats and suitable for readily consuming;
wherein said at least one animal blood(s) is collected from an animal said animal selected from the group consisting of cow, pig, deer, lamb, duck, chicken, and goose;
wherein said animal blood(s) includes at least 2 combinations of said animal blood(s);
wherein said blood patties comprise disks having dimensions approximately 3 to 4 inches in diameter, having a thickness of approximately ½ to 1-inch in thickness, and are such that they may be evenly and thoroughly cooked;
wherein said animal blood comprises an outer coating as formed said blood patties, said blood balls, and said blood burgers;
wherein said outer coating is selected from the group consisting of bread crumbs, beer batter, egg batter, and cornmeal batter;
wherein said cooking means when cooked are selected from the group consisting of deep frying, grilling, boiling, baking, and steaming;
wherein when said ready to eat blood patties, blood balls, and blood burgers when prepared via said deep frying, at least one cooking oil(s) is used;
wherein said cooking oil(s), when used, are selected from the group consisting of corn oil, canola oil, sunflower oil, peanut oil, olive oil, coconut oil, sesame oil, grape seed oil, flaxseed oil, soybean oil, pumpkin seed oil, safflower oil, argan oil, rice bran oil, palm oil, and palm kernel oil;
wherein said at least one seasoning is selected from the group consisting of salt, pepper, onion, garlic, ginger, curry, chili, vinegar, lemon, lime, peppermint, basil, thyme, parsley, rosemary, soup stock and broth, clove, cinnamon, coriander, cumin, and shallots;
wherein said blood patties, said blood balls, and said blood burgers are served in combination with at least one garnish, said at least one garnish is selected from the group consisting of lettuce, onions, tomatoes, pickles, and cheese;
wherein said blood patties, said blood balls, and said blood burgers are served in combination with sides, said sides are selected from the group consisting of bread buns, potatoes, rice, and pasta; and
wherein said blood patties, said blood balls, and said blood burgers are served in combination with at least one condiment, said at least one condiment are selected from the group consisting of mustard, mayonnaise, ketchup, and relish.

19. A method of preparing ready to eat blood patties, blood balls, and blood burgers comestible comprising the steps of:
drawing blood from at least one animal;
refrigerating said blood from said animal to create coagulation;
seasoning said blood from said animal;
cutting said blood from said animal into pieces of varying shapes and sizes to create said blood patties, said blood balls, and said blood burgers;
cooking said blood from said animal;
garnishing said blood patties, said blood balls, and said blood burgers with a bun and condiments; and
serving said ready to eat said blood patties, said blood balls, and said blood burgers as hot food in restaurants, said ready to eat said blood patties, said blood balls, and said blood burgers comestibles are packaged into air tight containers to preserve freshness until ready for consumption.

20. The method of claim 19 further comprising the step of consuming said blood patties, said blood balls, and said blood burgers.
